(19) United States
(12) Patent Application Publication
(10) Pub. No.: US 2013/0310452 A1
(43) Pub. Date: Nov. 21, 2013

(54) ANTIFUNGAL FLAVOURING INGREDIENTS AND COMPOSITIONS

(71) Applicants: Jérôme Barra, Geneva (CH); Evangelia Komitopoulou, Guilford (GB); Myriam Troccaz, Geneva (CH); Nathalie Vivien Castioni, Geneva (CH)

(72) Inventors: Jérôme Barra, Geneva (CH); Evangelia Komitopoulou, Guilford (GB); Myriam Troccaz, Geneva (CH); Nathalie Vivien Castioni, Geneva (CH)

(73) Assignee: FIRMENICH SA, Geneva 8 (CH)

(21) Appl. No.: 13/981,875

(22) PCT Filed: Jan. 9, 2012
(86) PCT No.: PCT/EP2012/050211

§ 371 Date: Jul. 25, 2013

(30) Foreign Application Priority Data
Feb. 7, 2011 (EP) 11153507.6

(51) Int. Cl. A23L 3/3544; A23L 3/349; A23L 3/3508; A23L 2/44

(52) U.S. Cl. CPC A23L 3/3544; A23L 2/44; A23L 3/349; A23L 3/3508
USPC 514/470

(57) ABSTRACT

The present invention relates to the use of flavouring ingredients and compositions as antifungal agents. The invention also relates to a method for preserving food products and beverages comprising adding said flavouring ingredients or compositions to the food product or beverage.

### TECHNICAL FIELD

The present invention relates to the use of flavouring ingredients and compositions as antifungal agents. The invention also relates to a method for preserving food products and beverages comprising adding said flavouring ingredients or compositions to the food product or beverage.

### BACKGROUND AND PRIOR ART

Preservation of food products and beverages is one of the main problems encountered in the food industry, due to the growth of yeast and moulds in such food products and beverages. Preservative materials having antifungal activity and in particular capable of inhibiting the growth of yeast strains and moulds which are mainly responsible for the spoilage of food products and beverages are therefore the object of constant research.

Several yeast and mould species are known to be responsible for the spoilage of food products and beverages. Mainly, yeasts such as Zygosaccharomyces rouxii, Saccharomyces cerevisiae, Pichia membranaefaciens, Candida crusei, Dekkera bruxellensis, Pichia anomala, Zygosaccharomyces bailii, Dekkera naardensis and Candida albicans and moulds such as Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii are involved in such food and beverage spoilage.

Due to the multitude of fungal species found to spoil food products and beverages, there is a need for effective non-specific preservative agents, with a broad spectrum of antifungal activity. Such agents will need to be compatible with a number of different preparations, including sweet and savoury food and drinks.

Since most of the food products and beverages are flavoured, it would be desirable that the flavouring ingredients also provide an antifungal effect since this would reduce the amount of additional antifungal ingredients required.

Several ingredients are known as having antifungal activity. Some of these ingredients are also used as flavouring compounds. For instance, WO 2009/133272 teaches that carvacrol and thymol are useful as preservative materials, which are active against microbial spoilage of beverages. Similarly, WO 2005/012210 describes the use of compounds such as perilla acid and geranic acid as preservative materials for food.

It would also be desirable to provide further preservative materials having antifungal activity and especially antifungal flavouring ingredients which are effective at very low dosage since flavouring ingredients cannot normally be used in high amounts without providing an overpowering flavour which is often undesirable to the consumer.

It is an object of the present invention to provide one or more of the above-mentioned benefits and/or to address one or more of the above-mentioned problems.

### SUMMARY OF THE INVENTION

Accordingly, the present invention provides for the use of at least one flavouring ingredient selected from 2-methylhexanoic acid, 3,4-dimethylphenol and (+)-(3S,3AS,6R,7AR)-perhydro-3,6-dimethyl-benzo[B]furan-2-one or of a flavouring composition comprising at least one of such flavouring ingredients as an antifungal agent.

In another aspect, the invention provides a method for preserving a food product or a beverage comprising adding to such food product or beverage at least one flavouring ingredient selected from 3,4-dimethylphenol, 2-methylhexanoic acid and (+)-(3S,3AS,6R,7AR)-perhydro-3,6-dimethyl-benzo[B]furan-2-one or a flavouring composition comprising at least one of such flavouring ingredients.

In a further aspect, the present invention relates to an antifungal agent in the form of a composition comprising at least one ingredient selected from 2-methylhexanoic acid, 3,4-dimethylphenol and (+)-(3S,3AS,6R,7AR)-perhydro-3,6-dimethyl-benzo[B]furan-2-one.

In still another aspect, the present invention relates to a food product or beverage comprising an antifungal agent of the invention.

### DETAILED DESCRIPTION OF THE INVENTION

3,4-Dimethylphenol, 2-methylhexanoic acid, (+)-(3S,3AS,6R,7AR)-perhydro-3,6-dimethyl-benzo[B]furan-2-one and flavouring compositions comprising such ingredients surprisingly have antifungal activity and provide efficient activity as preservative for food products and beverages.

In other words, the use of such an ingredient or composition as antifungal agent refers to a method for killing, inhibiting or inactivating at least a proportion of one or more strains of fungus, comprising contacting said fungus with the flavouring ingredient or composition.

Preferably, the contacting step consists in adding the flavouring ingredient or composition to a food product or to a beverage, in which the fungus strain is present or is expected to grow.

### Antifungal Activity of Ingredients and Compositions

The term “antifungal” is used to mean effective to kill, inhibit or inactivate at least a proportion of one or more strains of fungus, such as yeast and/or mould.

Preferably, it refers to the ability of an ingredient or composition to effectively inhibit the growth of at least two strains selected from Zygosaccharomyces rouxii, Saccharomyces cerevisiae, Pichia membranaefaciens, Candida crusei, Dekkera bruxellensis, Pichia anomala, Zygosaccharomyces bailii, Dekkera naardensis, Candida albicans, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii and more preferably selected from Zygosaccharomyces rouxii, Saccharomyces cerevisiae, Pichia membranaefaciens, Candida crusei, Dekkera bruxellensis, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti and Fusarium oxysporum.

More preferably the ingredient or composition has antifungal activity against three or more, or even four or more of the above mentioned fungal strains.

In a preferred aspect of the invention, the flavouring ingredient or composition for the purpose of the present invention is effective as antifungal agent at concentrations of 1000 ppm or less, preferably of 500 ppm or less, more preferably of 250 ppm or less, most preferably of 125 ppm or less.

The term “effective” when used to describe the capacity of a compound or composition to inhibit growth of a yeast or mould strain is defined as the ability of such ingredient or composition to inhibit growth of the strain in a growth medium consisting of a 105 g/L sucrose solution with an initial inoculum of 10²-10³ cfu/mL of such yeast or mould strain, so that the average optical density of the growth medium, as measured at 380 nm for yeast strains and at 500 nm for mould strains, is maintained below 0.2 after 21 days of culture at 21° C. or 25° C. under aerobic conditions. The growth medium of which the optical density is measured consists of the growth medium as it is at the end of the 21 days growth period. It therefore consists of the growth medium (sucrose solution at 105 g/L), together with the organisms which were able to grow during the 21 days culture period and the flavouring ingredient or composition.

For the purposes of the present invention, growth inhibition activity of a given compound against one of the above mentioned strains is measured as follows.

A 105 g/L solution of sucrose in water is prepared. Preferably, the sucrose solution is at pH 3±0.2 or at pH 5±0.2. When the sucrose solution pH is set to one of these values, the solution is preferably autoclaved at 121° C. for 15 minutes and the pH is then re-checked to ensure that it remains within the required range.

Test samples are prepared in a microtiter plate comprising 100 μL of one of the sucrose solutions prepared above, together with an initial inoculum of the fungal strain of which growth is intended to be inhibited, so as to achieve a microbial level comprised between 10² and 10³ cfu/mL.

The flavouring ingredient or composition of which the antifungal activity is intended to be evaluated is then added to the microtiter plate. Dilutions of the tested flavouring ingredient or composition in each test sample are prepared in a microtiter plate to afford final concentrations of 1000 ppm, 500 ppm, 250 ppm and 125 ppm. The microtiter plates are then stored in a standard incubator under aerobic conditions at 21° C. or at 25° C.

The optical density (OD) of each sample is measured just after addition of the flavouring ingredient or composition (control) and after 21 days of incubation. The OD is measured at 380 nm for yeast strains and at 500 nm for mould strains.

All tests are done in triplicate to ensure statistical relevance of the results obtained.

Growth inhibition of a particular strain by an ingredient at a particular concentration is given if the OD measured after 21 days of culture in these conditions is below 0.2, provided that the same effect is also observed with a higher concentration of the active ingredient.

### Flavouring Ingredient or Flavouring Composition Having Antifungal Effect

The flavouring ingredients 3,4-dimethylphenol, 2-methylhexanoic acid and (+)-(3S,3AS,6R,7AR)-perhydro-3,6-dimethyl-benzo[B]furan-2-one were identified as being particularly efficient to inhibit growth of the yeast and mould strains mentioned above. These flavouring ingredients, as well as flavouring compositions comprising them, can therefore advantageously be used as antifungal ingredients for the preservation of food products and beverages.

Flavouring compositions are meant here as carefully balanced mixtures of flavouring ingredients. Preferably, 3,4-dimethylphenol, 2-methylhexanoic acid or (+)-(3S,3AS,6R,7AR)-perhydro-3,6-dimethyl-benzo[B]furan-2-one is present in an amount of from 1 to 25% by weight, more preferably 7.5 to 25%, most preferably 12.5 to 25% by weight, based on the total weight of the composition.

Such flavouring compositions preferably comprise at least one additional ingredient having antifungal activity, as described above in any particular aspect of the invention. Among such suitable additional ingredients, one can mention salicylic acid, carvacrol, dihydro eugenol, farnesol, a mixture of 2-tert-butyl-4-methoxypehenol and 3-tert-butyl-4-methoxyphenol, thymol, 7-methyl-3-octen-2-one, 5-methyl-2-phenyl-2-hexenal, orcinyle (3-methoxy-5-methylphenol), maniguette seed extract, orange extract (for example Tetrarome® orange, origin: Firmenich SA, Geneva, Switzerland), 2-pentylfuran and terpinolene. This list is not exhaustive and the skilled person will, following the protocol detailed above for establishing antifungal activity, readily ascertain whether a flavouring ingredient has the desired antifungal activity. Particularly preferred additional flavouring ingredients include 5-methyl-2-phenyl-2-hexenal, dihydroeugenol and terpinolene.

More preferably, the flavouring composition used in the present invention comprises at least two of such additional ingredients.

Whilst the choice of ingredients will be dictated by their antifungal activity as described above, they should either be capable of providing a flavouring effect in the composition or be flavour neutral so that they can easily be incorporated into the end products mentioned herein. Such ingredients therefore preferably do not confer any off-note to the composition.

It is preferred, in the context of the present invention, to use a flavouring composition rather than a flavouring ingredient as such. More preferably the composition comprises at least three ingredients, since it is preferable that the composition not only provides antifungal benefits but also has a balanced flavour profile. When only one ingredient is used, then the flavour may be unbalanced whereas when two or more flavours are present, less of each ingredient is required and the inherent risk of unbalanced, overpowering flavours is diminished.

In a preferred aspect of the invention each additional ingredient is used in an amount of between 1 and 25% by weight, preferably between 7.5 and 25% by weight and more preferably between 12.5 and 25% by weight, relative to the total weight of the flavouring composition.

Since the flavour composition is typically incorporated into the final product at a level of 0.03 to 1% by weight, more preferably 0.05 to 0.5% by weight, most preferably 0.05 to 0.3% by weight, the flavouring ingredient or composition can surprisingly be present in very small amounts and yet still remain effective. For instance, the antifungal ingredient or composition may be present in an amount of from 0.004 to 0.5%, more preferably more preferably 0.0075 to 0.05% by weight, based on the total weight of the final food product or beverage.

The flavouring ingredients or composition used in the present invention may be used to replace, in whole or in part, conventional preservative materials used in food products or beverages, without diminishing preservation of said food product or beverage. By “conventional preservative materials”, it is meant preservative antifungal materials that are not associated with any flavouring characteristics and often have an undesirable aroma or taste, which must then be masked using known flavour ingredients. The presence of such preservative agent may further cause throat burn. Artificial antifungal agents also require appropriate labelling, which leads to a commercial drawback.

The antifungal flavouring ingredient of compositions used in the invention can be combined with conventional preservative agents, in which case this has been found to provide a synergistic effect reinforcing the antifungal character of such ingredients.

By its antifungal and flavouring properties, a flavouring ingredient or composition used according to the invention is equally suitable for any type of food product and/or beverage.

The flavouring compositions used in the invention may contain other constituents which have a positive or synergistic effect on the antifungal activity of the ingredients.

The flavouring ingredients, the flavouring composition or any ingredient of the flavouring composition can be incorporated in a delivery system or in a liquid emulsion or may be encapsulated following standard procedures.

Encapsulation of the flavouring ingredient or composition can be used in food products and beverages and is advantageous because it enables controlled release of the ingredient composition and is desirable where delivery of a concentrated dose is required. When the whole composition is encapsulated, it also enables simultaneous release of all ingredients. It is believed that this may further improve the antifungal efficiency of the ingredients and compositions. Encapsulation of the active ingredients has also an advantageous protective effect. The use of encapsulated antifungal agents is particularly advantageous in food products such as chewing-gum, candies and tablets.

The person skilled in the art is well aware of a variety of encapsulation systems which are suitable for this purpose, the following being preferred for their properties of providing very good barriers to oxidation.

A first preferred encapsulating system is a glassy matrix within which the flavouring composition or ingredient is held. More preferably the encapsulation system is a glassy carbohydrate matrix. The carbohydrate matrix ingredient preferably comprises a sugar derivative, more preferably maltodextrin.

Particularly preferred maltodextrins are those with a DE of from 10 to 30, more preferably from 15 to 25, most preferably from 17 to 19.

Typically, the flavouring ingredient or composition is admixed with a carbohydrate matrix material and an appropriate amount of a plasticizer, such as water, the mixture is heated within a screw extruder to a temperature above the glass transition temperature of the matrix material so as to form a molten mass capable of being extruded through a die and then the molten mass is extruded using established processes, such as described in the prior art. See, for instance, patent application WO 00/25606, published May 11, 2002 or WO 01/17372, published Mar. 15, 2001, and the documents cited therein, the contents of which are hereby included by reference.

If desired, further carbohydrate matrix components may be present to further improve the antioxidant barrier properties.

Other suitable encapsulation systems are described in, for example, U.S. Pat. No. 4,610,890 or U.S. Pat. No. 4,707,367, the contents of which are included by reference.

### Other Flavouring Ingredients

The flavouring ingredient or composition used in the present invention as antifungal agent optionally comprises at least one flavouring ingredient of current use, typically incorporated into the food product or beverage.

The term “flavouring ingredient of current use” is defined here as encompassing flavouring ingredients or compositions of both natural and synthetic origin used in the flavours industry. It includes single compounds and mixtures. Specific examples of such flavour ingredients may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). Many other examples of current flavouring ingredients may be found in the patent and general literature available. The flavouring ingredients may be present in the form of a mixture with solvents, adjuvants, additives and/or other components, generally those of current use in the flavour industry.

“Flavouring ingredients” are well known to a person skilled in the art of aromatising as being capable of imparting a flavour or taste to a consumer product, or of modifying the taste and/or flavour of said consumer product, or yet its texture or mouthfeel.

### End Products

The flavouring ingredients or compositions can be used in any type of food product or beverage to be preserved.

Examples of beverages include carbonated soft drink, functional soft drinks, juices and nectars, hot drinks and alcoholic drinks. The compositions of the invention are particularly useful when such beverages are sweet beverages, preferably comprising any type of sugar or sugar derivatives. Food products in which the compositions of the invention can be advantageously used are sweet as well as savoury products, and in particular all types of food products comprising water, more preferably comprising water and any type of sugar or sugar derivatives. Examples of such food products include for example soups, sauce, dressings, marinades, dairy products such as desserts, ice-cream, spreads and cheese, refrigerated food, acidified food, such as for example pickles, meat products and prepared fruits and vegetables.

### Method for Preserving a Food Product or a Beverage

The present invention also provides a method for preserving a food product or a beverage comprising adding to such food product or beverage 3,4-dimethylphenol, 2-methylhexanoic acid and/or (+)-(3S,3 AS, 6R,7 AR)-perhydro-3,6-dimethyl-benzo[B]furan-2-one or a composition comprising at least one of these flavouring ingredients.

The flavouring composition, the food product and the beverages are as defined above in any general or preferred aspect of the invention. The proportions in which the flavouring ingredient or composition can be added to the food product or the beverage are also as described above.

### Antifungal Agent

The present invention provides an antifungal agent in the form of a composition comprising at least one ingredient selected from 2-methylhexanoic acid, 3,4-dimethylphenol and (+)-(3S,3AS,6R,7AR)-perhydro-3,6-dimethyl-benzo furan-2-one.

Such composition preferably also comprises at least one ingredient capable of inhibiting the growth of at least two yeast and/or mould strains selected from Zygosaccharomyces rouxii, Saccharomyces cerevisiae, Pichia membranaefaciens, Candida crusei, Dekkera bruxellensis, Pichia anomala, Zygosaccharomyces bailii, Dekkera naardensis Candida albicans, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti, Fusarium oxysporum, and Mucor rouxii in a medium consisting of a 105 g/L sucrose solution with an initial inoculum of 10²-10³ cfu/mL of such yeast or mould strains, so that the average optical density of the growth medium, as measured at 380 nm for yeast strains and at 500 nm for mould strains, is maintained below 0.2 after 21 days of culture at 21° C. or 25° C. under aerobic conditions. Preferably, said yeast and/or mould strain is selected from Zygosaccharomyces rouxii, Saccharomyces cerevisiae, Pichia membranaefaciens, Candida crusei, Dekkera bruxellensis, Byssochlamys nivea, Byssochlamys fulva, Neosartorya fischeri, Talaromyces harzanium, Fusarium solani, Aspergillus fumigatis, Aspergillus niger, Penicillium crustosum, Penicillium digitatum, Penicillium roqueforti and Fusarium oxysporum.

Most preferably such additional ingredient is a flavouring ingredient or composition having an antifungal effect, as defined in any of the above embodiments.

### EXAMPLES

The invention will now be illustrated by way of the following examples. All amounts are percentages by weight unless otherwise stated.

### Example 1

### Preparation of a Composition for Use as an Antifungal Agent According to the Invention

Composition A was prepared having the following ingredients in the amount indicated.

TABLE 1
Composition of Composition A

| Ingredient | Parts [%] |
|---|---|
| 3,4-Dimethylphenol | 8.0 |
| 2-methylhexanoic acid | 91.0 |
| (+)-(3S,3AS,6R,7AR)-perhydro-3,6- | 1 |
| dimethyl-benzo[B]furan-2-one | |
| (10% solution in propylene glycol) | |
| Total | 100 |

### Example 2

### Preparation of a Composition for Use as an Antifungal Agent According to the Invention

Composition B was prepared having the following ingredients in the amount indicated.

TABLE 2
Composition of Composition B

| Ingredient | Parts [%] |
|---|---|
| 3,4-Dimethylphenol | 8.0 |
| 2-methylhexanoic acid | 40.0 |
| (+)-(3S,3AS,6R,7AR)-perhydro-3,6- | 1.0 |
| dimethyl-benzo[B]furan-2-one | |
| (10% solution in propylene glycol) | |
| Terpinolene | 51.0 |
| Total | 100 |

### Example 3

### Preparation of a Composition for Use as an Antifungal Agent According to the Invention

Composition C was prepared having the following ingredients in the amount indicated.

TABLE 3
Composition of Composition C

| Ingredient | Parts [%] |
|---|---|
| Geranic acid | 10.0 |
| 3,4-Dimethylphenol | 6.0 |
| 2-methylhexanoic acid | 1.0 |
| (+)-(3S,3AS,6R,7AR)-perhydro-3,6- | 0.5 |
| dimethyl-benzo[B]furan-2-one | |
| (10% solution in propylene glycol) | |
| Terpinolene | 82.5 |
| Total | 100 |

### Example 4

### Preparation of a Composition for Use as an Antifungal Agent According to the Invention

Composition D was prepared having the following ingredients in the amount indicated.

TABLE 4
Composition of Composition D

| Ingredient | Parts [%] |
|---|---|
| 3,4 -Dimethylphenol | 6.0 |
| 2-methylhexanoic acid | 1.0 |
| (+)-(3S,3AS,6R,7AR)-perhydro-3,6- | 0.5 |
| dimethyl-benzo[B]furan-2-one | |
| (10% solution in propylene glycol) | |
| Terpinolene | 87.5 |
| 5-Methyl-2-phenyl-2-hexenal | 5.0 |
| Total | 100 |

### Example 5

Determination of the Antifungal Activity of Several Flavouring Ingredients and Compositions

The antifungal activity of various flavouring ingredients was evaluated against the following yeast strains: Zygosaccharomyces rouxii (DSM70835), Pichia membranaefaciens (DSM 70369), Dekkera Bruxellensis (DSM70726), Saccharomyces cerevisiae (DSM 70869) and Candida krusei (origin: Leatherhead Food Research) and against the following moulds strains: Byssochlamys nivea, Fusarium solani, Aspergillus fumigatis, Byssochlamys fulva, Aspergillus niger, Talaromyces Harzanium, Penicillium crustosum, Penicillium digitatum, Neosartorya fischeri, Penicillium roquerforti, Fusarium oxysporum.

A 105 g/L solution of sucrose in water at pH 3±0.2 was prepared. Another sucrose solution at the same concentration at pH 5±0.2 was also prepared. The sucrose solutions were autoclaved at 121° C. for 15 minutes and the pH was re-checked to ensure it remained within the range.

Test samples were then prepared in microtiter plates. An amount of 100 μL of sucrose solution prepared above, were mixed with an inoculum of 20 μL of one fungal strain, so as to achieve a microbial level comprised between 10² and 10³ cfu/mL.

The flavouring ingredient or composition was then added to the microtiter plate. Dilutions were prepared in the microtiter plate for each mixture of sucrose solution and inoculum to afford final concentrations of 2000 ppm, 1000 ppm, 500 ppm, 250 ppm and 125 ppm of the ingredient or composition to be tested. One well for each mixture of sucrose solution and inoculum was kept free of flavouring ingredient or composition, to serve as a control.

The microtiter plates were then stored in a standard 25° C. incubator under aerobic conditions.

The optical density (OD) of each sample was measured after 21 days of incubation using a Bio-Tek Synergy™ HT Multi-Mode Microplate Reader (from Labtech International, UK). The wavelength was set to 380 nm for yeast strains and to 500 nm for mould strains. All tests were done in triplicate to ensure statistical relevance of the results.

The following tables indicate the OD measurements obtained when each flavouring ingredient or composition was used to inhibit growth of yeast and mould strains involved at concentration ranging between 0 and 2000 ppm. Measurements corresponding to efficient growth inhibition are indicated by grey cells in the tables below. Results were considered as evidence of efficient growth inhibition when the OD of the growth medium was below 0.2. OD measurements below 0.2 were not considered as sufficient evidence of the antifungal activity of a given flavouring ingredient or composition at a given concentration if OD measurements obtained with a higher concentration of such flavouring ingredient or composition were above 0.2.

TABLE 5
OD measurements obtained using Composition A as antifungal agent at pH 3

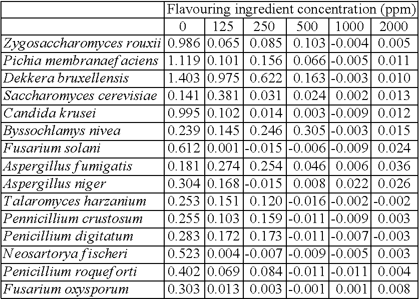

These results show that the use of Composition A in a sucrose solution at pH 3 has a strong antifungal effect against 15 of the main fungi responsible for beverage and food spoilage at concentrations of 1000 ppm or less. It can therefore be advantageously used as a preservative composition in such food products or beverages.

TABLE 6
OD measurements obtained using Composition A as antifungal agent at pH 5

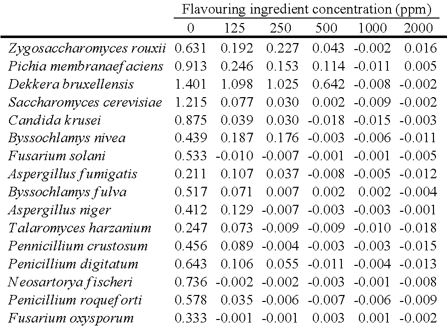

These results show that the use of Composition A in a sucrose solution at pH 5 has a strong antifungal effect against 16 of the main fungi responsible for beverage and food spoilage at concentrations of 1000 ppm or less. It can therefore be advantageously used as a preservative composition in such food products or beverages.

TABLE 7
OD measurements obtained using Composition B as antifungal agent at pH 3

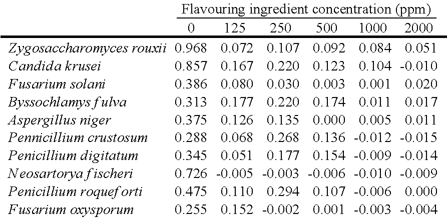

These results show that the use of Composition B in a sucrose solution at pH 3 has a strong antifungal effect against 10 of the main fungi responsible for beverage and food spoilage at concentrations of 1000 ppm or less. It can therefore be advantageously used as a preservative composition in such food products or beverages.

TABLE 8
OD measurements obtained using
Composition B as antifungal agent at pH 5

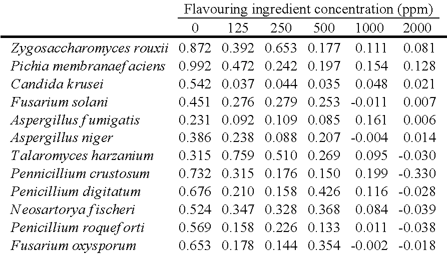

These results show that the use of Composition B in a sucrose solution at pH 5 has a strong antifungal effect against 12 of the main fungi responsible for beverage and food spoilage at concentrations of 1000 ppm or less. It can therefore be advantageously used as a preservative composition in such food products or beverages.

TABLE 9
OD measurements obtained using salicylic acid as antifungal agent at pH 3

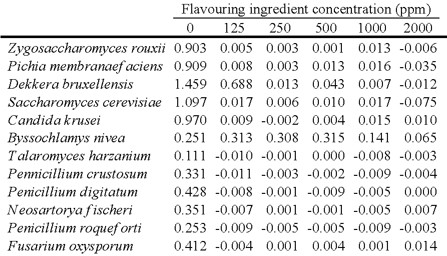

These results show that the use of salicylic acid in a sucrose solution at pH 3 has a strong antifungal effect against 12 of the main fungi responsible for beverage and food spoilage at concentrations of 1000 ppm or less. It can therefore be advantageously used as a preservative composition in such food products or beverages.

TABLE 10
OD measurements obtained using salicylic acid as antifungal agent at pH 5

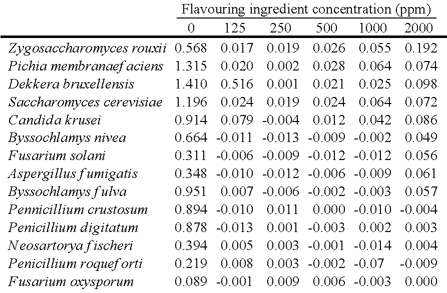

These results show that the use of salicylic acid in a sucrose solution at pH 5 has a strong antifungal effect against 14 of the main fungi responsible for beverage and food spoilage at concentrations of 1000 ppm or less. It can therefore be advantageously used as a preservative composition in such food products or beverages.

TABLE 11
OD measurements obtained using carvacrol as antifungal agent at pH 3

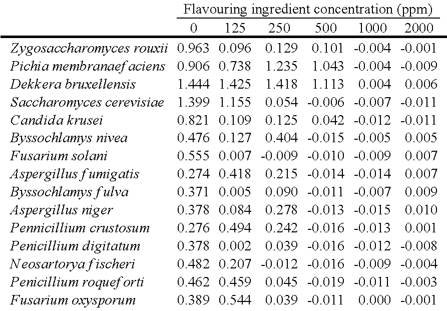

These results show that the use of carvacrol in a sucrose solution at pH 3 has a strong antifungal effect against 15 of the main fungi responsible for beverage and food spoilage at concentrations of 1000 ppm or less. It can therefore be advantageously used as a preservative composition in such food products or beverages.

TABLE 12
OD measurements obtained using carvacrol as antifungal agent at pH 5

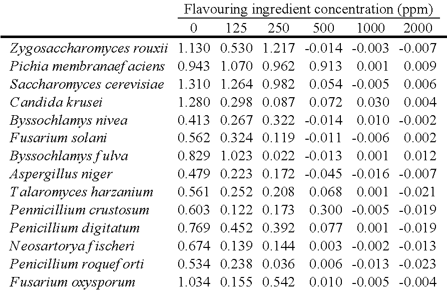

These results show that the use of carvacrol in a sucrose solution at pH 5 has a strong antifungal effect against 14 of the main fungi responsible for beverage and food spoilage at concentrations of 1000 ppm or less. It can therefore be advantageously used as a preservative composition in such food products or beverages.

TABLE 13
OD measurements obtained using dihydro
eugenol as antifungal agent at pH 3

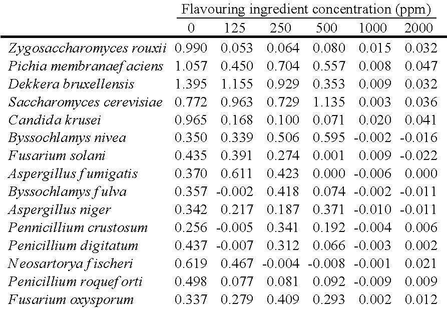

These results show that the use of dihydro eugenol in a sucrose solution at pH 3 has a strong antifungal effect against 15 of the main fungi responsible for beverage and food spoilage at concentrations of 1000 ppm or less. It can therefore be advantageously used as a preservative composition in such food products or beverages.

TABLE 14
OD measurements obtained using dihydro
eugenol as antifungal agent at pH 5

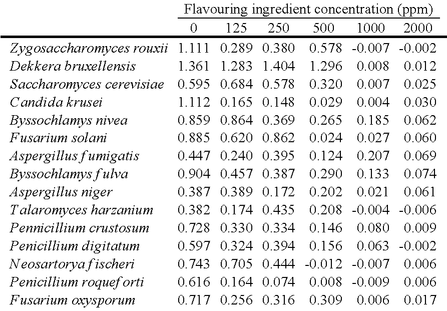

These results show that the use of dihydro eugenol in a sucrose solution at pH 5 has a strong antifungal effect against 15 of the main fungi responsible for beverage and food spoilage at concentrations of 1000 ppm or less. It can therefore be advantageously used as a preservative composition in such food products or beverages.

TABLE 15
OD measurements obtained using farnesol as an antifungal agent at pH 3

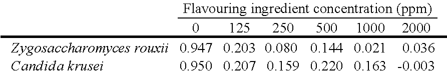

These results show that the use of farnesol in a sucrose solution at pH 3 has a strong antifungal effect against 2 of the main fungi responsible for beverage and food spoilage at concentrations of 1000 ppm or less. It can therefore be advantageously used as a preservative composition in such food products or beverages.

TABLE 16
OD measurements obtained using a mixture of 2-tert-butyl-4-methoxy-
phenol and 3-tert-butyl-4-methoxyphenol as antifungal agent at pH 3

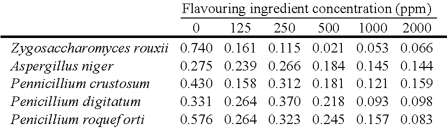

These results show that the use of a mixture of 2-tert-butyl-4-methoxyphenol and 3-tert-butyl-4-methoxyphenol in a sucrose solution at pH 3 has a strong antifungal effect against 5 of the main fungi responsible for beverage and food spoilage at concentrations of 1000 ppm or less. It can therefore be advantageously used as a preservative composition in such food products or beverages.

TABLE 17
OD measurements obtained using a mixture of 2-tert-butyl-4-methoxy-
phenol and 3-tert-butyl-4-methoxyphenol as antifungal agent at pH 5

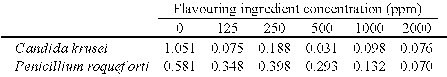

These results show that the use of a mixture of 2-tert-butyl-4-methoxyphenol and 3-tert-butyl-4-methoxyphenol in a sucrose solution at pH 5 has a strong antifungal effect against 2 of the main fungi responsible for beverage and food spoilage at concentrations of 1000 ppm or less. It can therefore be advantageously used as a preservative composition in such food products or beverages.

TABLE 18
OD measurements obtained using thymol as antifungal agent at pH 3

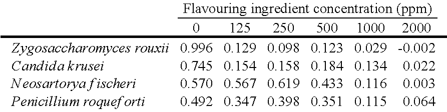

These results show that the use of thymol in a sucrose solution at pH 3 has a strong antifungal effect against 4 of the main fungi responsible for beverage and food spoilage at concentrations of 1000 ppm or less. It can therefore be advantageously used as a preservative composition in such food products or beverages.

TABLE 19
OD measurements obtained using 7-methyl-
3-octen-2-one as antifungal agent at pH 3

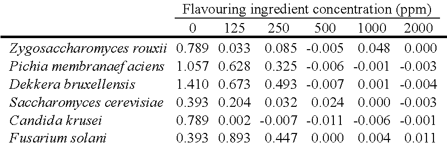

These results show that the use of 7-methyl-3-octen-2-one in a sucrose solution at pH 3 has a strong antifungal effect against 6 of the main fungi responsible for beverage and food spoilage at concentrations of 1000 ppm or less. It can therefore be advantageously used as a preservative composition in such food products or beverages.

TABLE 20
OD measurements obtained using 7-methyl-
3-octen-2-one as antifungal agent at pH 5

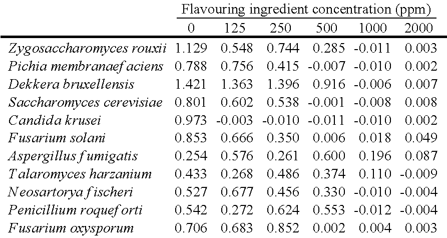

These results show that the use of 7-methyl-3-octen-2-one in a sucrose solution at pH 5 has a strong antifungal effect against 11 of the main fungi responsible for beverage and food spoilage at concentrations of 1000 ppm or less. It can therefore be advantageously used as a preservative composition in such food products or beverages.

TABLE 21
OD measurements obtained using 3,4-
dimethylphenol as antifungal agent at pH 3

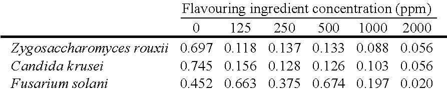

These results show that the use of 3,4-dimethylphenol in a sucrose solution at pH 3 has a strong antifungal effect against 3 of the main fungi responsible for beverage and food spoilage at concentrations of 1000 ppm or less. It can therefore be advantageously used as a preservative composition in such food products or beverages.

TABLE 22
OD measurements obtained using 2-methylhexanoic acid at pH 3

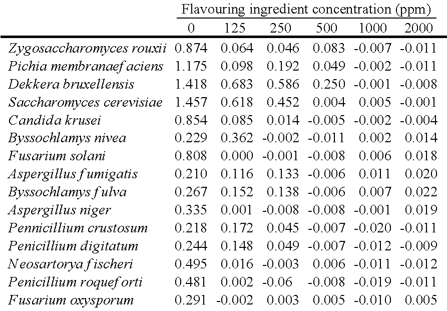

These results show that the use of 2-methylhexanoic acid in a sucrose solution at pH 3 has a strong antifungal effect against 15 of the main fungi responsible for beverage and food spoilage at concentrations of 1000 ppm or less. It can therefore be advantageously used as a preservative composition in such food products or beverages.

TABLE 23
OD measurements obtained using 2-methyl-
hexanoic acid as antifungal agent at pH 5

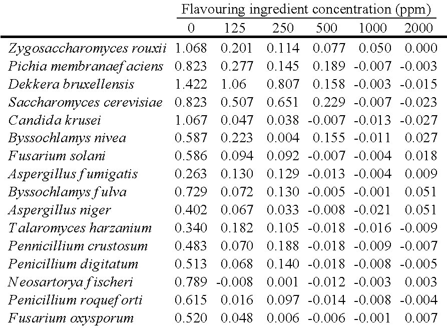

These results show that the use of 2-methylhexanoic acid in a sucrose solution at pH 5 has a strong antifungal effect against 16 of the main fungi responsible for beverage and food spoilage at concentrations of 1000 ppm or less. It can therefore be advantageously used as a preservative composition in such food products or beverages.

TABLE 24
OD measurements obtained using 5-methyl-
2-phenyl-2-hexenal as antifungal agent at pH 3

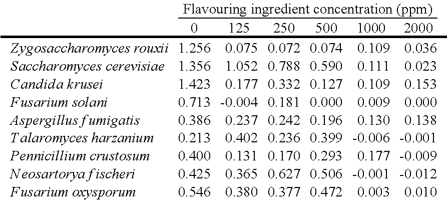

These results show that the use of 5-methyl-2-phenyl-2-hexenal in a sucrose solution at pH 3 has a strong antifungal effect against 9 of the main fungi responsible for beverage and food spoilage at concentrations of 1000 ppm or less. It can therefore be advantageously used as a preservative composition in such food products or beverages.

TABLE 25
OD measurements obtained using 5-methyl-
2-phenyl-2-hexenal as antifungal agent at pH 5

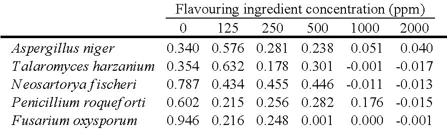

These results show that the use of 5-methyl-2-phenyl-2-hexenal in a sucrose solution at pH 5 has a strong antifungal effect against 5 of the main fungi responsible for beverage and food spoilage at concentrations of 1000 ppm or less. It can therefore be advantageously used as a preservative composition in such food products or beverages.

TABLE 26
OD measurements obtained using orcinyle as antifungal agent at pH 3

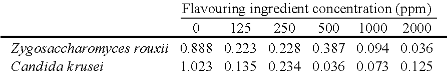

These results show that the use of orcinyle in a sucrose solution at pH 3 has a strong antifungal effect against 2 of the main fungi responsible for beverage and food spoilage at concentrations of 1000 ppm or less. It can therefore be advantageously used as a preservative composition in such food products or beverages.

TABLE 27
OD measurements obtained with (+)-(3S,3AS,6R,7AR)-
perhydro-3,6-dimethyl-benzo[B]furan-2-one at pH 3

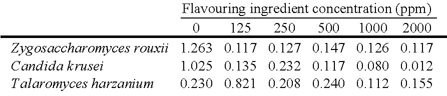

These results show that the use of (+)-(3S,3AS,6R,7AR)-perhydro-3,6-dimethyl-benzo[B]furan-2-one in a sucrose solution at pH 3 has a strong antifungal effect against 3 of the main fungi responsible for beverage and food spoilage at concentrations of 1000 ppm or less. It can therefore be advantageously used as a preservative composition in such food products or beverages.

TABLE 28
OD measurements obtained using (+)-(3S,3AS,6R,7AR)-
perhydro-3,6-dimethyl-benzo[B]furan-2-one as antifungal agent at pH 5

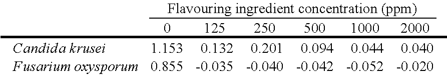

These results show that the use of (+)-(3S,3AS,6R,7AR)-perhydro-3,6-dimethyl-benzo[B]furan-2-one in a sucrose solution at pH 5 has a strong antifungal effect against 2 of the main fungi responsible for beverage and food spoilage at concentrations of 1000 ppm or less. It can therefore be advantageously used as a preservative composition in such food products or beverages.

TABLE 29
OD measurements obtained using maniguette
seed extract as antifungal agent at pH 3

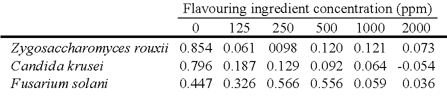

These results show that the use of maniguette seed extract in a sucrose solution at pH 3 has a strong antifungal effect against 3 of the main fungi responsible for beverage and food spoilage at concentrations of 1000 ppm or less. It can therefore be advantageously used as a preservative composition in such food products or beverages.

TABLE 30
OD measurements obtained with maniguette seed extract at pH 5

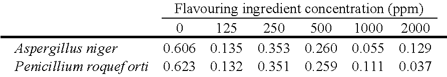

These results show that the use of maniguette seed extract in a sucrose solution at pH 5 has a strong antifungal effect against 2 of the main fungi responsible for beverage and food spoilage at concentrations of 1000 ppm or less. It can therefore be advantageously used as a preservative composition in such food products or beverages.

TABLE 31
OD measurements obtained using orange extract
(Tetrarome ® orange, origin: Firmenich SA,
Geneva, Switzerland) as antifungal agent at pH 3

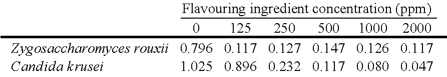

These results show that the use of Tetrarome® orange in a sucrose solution at pH 3 has a strong antifungal effect against 2 of the main fungi responsible for beverage and food spoilage at concentrations of 1000 ppm or less. It can therefore be advantageously used as a preservative composition in such food products or beverages.

TABLE 32
OD measurements obtained using 2-pentylfuran as antifungal agent at pH 3

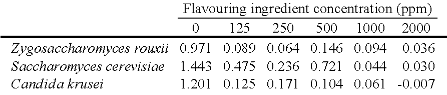

These results show that the use of 2-pentylfuran in a sucrose solution at pH 3 has a strong antifungal effect against 3 of the main fungi responsible for beverage and food spoilage at concentrations of 1000 ppm or less. It can therefore be advantageously used as a preservative composition in such food products or beverages.

TABLE 33
OD measurements obtained using 2-pentylfuran as antifungal agent at pH 5

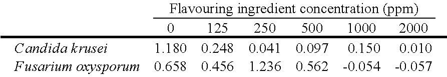

These results show that the use of 2-pentylfuran in a sucrose solution at pH 5 has a strong antifungal effect against 2 of the main fungi responsible for beverage and food spoilage at concentrations of 1000 ppm or less. It can therefore be advantageously used as a preservative composition in such food products or beverages.

TABLE 34
OD measurements obtained using terpinolene as antifungal agent at pH 3

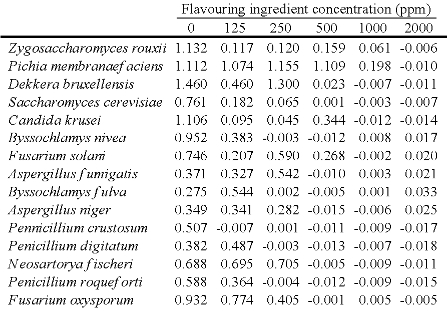

These results show that the use of terpinolene in a sucrose solution at pH 3 has a strong antifungal effect against 15 of the main fungi responsible for beverage and food spoilage at concentrations of 1000 ppm or less. It can therefore be advantageously used as a preservative composition in such food products or beverages.

TABLE 35
OD measurements obtained using terpinolene as antifungal agent at pH 5

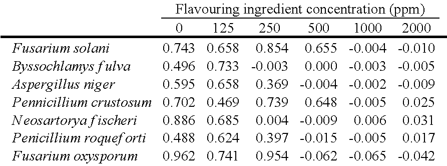

These results show that the use of terpinolene in a sucrose solution at pH 5 has a strong antifungal effect against 7 of the main fungi responsible for beverage and food spoilage at concentrations of 1000 ppm or less. It can therefore be advantageously used as a preservative composition in such food products or beverages.

1-7. (canceled)

7. A method for preserving a food product or a beverage comprising adding at least one flavouring ingredient selected from 3,4-dimethylphenol, 2-methylhexanoic acid and (+)-(3S,3AS,6R,7AR)-perhydro-3,6-dimethyl-benzo[B]furan-2-one or a flavouring composition comprising at least one of such flavouring ingredients to the food product or to the beverage.

8. A method according to claim 7, wherein the flavouring composition further comprises at least one flavouring ingredient capable, at a concentration of 1000 ppm or less, of inhibiting the growth of two or more strains selected from yeast strains Zygosaccharomyces rouxii, Saccharomyces cerevisiae, Pichia membranaefaciens, Candida crusei and Dekkera bruxellensis and mould strains Byssochlamys nivea, Byssochlamys fulva, Neosartorya fischeri, Penicillium crusotsum, Penicillium digitatum, Penicillium roqueforti and fusarium oxysporum in a growth medium consisting of a 105 g/L sucrose solution with an initial inoculum of 10²-10³ cfu/mL of such yeast or mould strain, so that the average optical density of the growth medium, as measured at 380 nm for yeast strains and at 500 nm for mould strains, is maintained below 0.2 after 21 days of culture at 21° C. or 25° C. under aerobic conditions.

9. A method according to claim 8, wherein said further flavouring ingredients is selected from salicylic acid, carvacrol, dihydro eugenol, farnesol, a mixture of 2-tert-butyl-4-methoxyphenol and 3-tert-butyl-4-methoxyphenol, thymol, 7-methyl-3-octen-2-one, 5-methyl-2-phenyl-2-hexenal, 3-methoxy-5-methylphenol, maniguette seed extract, orange extract, 2-pentylfuran and terpinolene.

10. A method according to claim 9, wherein said further flavouring ingredient is selected from 5-methyl-2-phenyl-2-hexenal, dihydroeugenol and terpinolene.

11. A method according to claim 7, wherein the flavouring composition comprises from 1 to 25% by weight of 3,4-dimethylphenol, 2-methylhexanoic acid and/or (+)-(3S,3AS,6R,7AR)-perhydro-3,6-dimethyl-benzo[B]furan-2-one.

12. A method according to claim 7, wherein the beverage is selected from sweet beverages comprising sugar or a sugar derivative.

13. A method according to claim 7, wherein the beverage is selected from carbonated soft drinks, functional soft drinks, juices and nectars, hot drinks, and alcoholic drinks.

14. A method according to claim 7, wherein the food product is selected from soups, sauces, dressings, marinades, dairy products, refrigerated food, acidified food, meat products and prepared fruits and vegetables.

15. An antifungal agent in the form of a composition comprising at least one ingredient selected from 2-methylhexanoic acid, 3,4-dimethylphenol and (+)-(3S,3AS,6R,7AR)-perhydro-3,6-dimethyl-benzo[B]furan-2-one.

16. A method according to any one of claim 8, wherein the flavouring composition comprises from 1 to 25% by weight of 3,4-dimethylphenol, 2-methylhexanoic acid and/or (+)-(3S,3AS,6R,7AR)-perhydro-3,6-dimethyl-benzo[B]furan-2-one.

17. A method according to any one of claim 9, wherein the flavouring composition comprises from 1 to 25% by weight of 3,4-dimethylphenol, 2-methylhexanoic acid and/or (+)-(3S,3AS,6R,7AR)-perhydro-3,6-dimethyl-benzo[B]furan-2-one.

18. A method according to any one of claim 10, wherein the flavouring composition comprises from 1 to 25% by weight of 3,4-dimethylphenol, 2-methylhexanoic acid and/or (+)-(3S,3AS,6R,7AR)-perhydro-3,6-dimethyl-benzo[B]furan-2-one.
